(19) United States
(12) Patent Application Publication
(10) Pub. No.: US 2026/0046851 A1
(43) Pub. Date: Feb. 12, 2026

(54) SYSTEM AND METHOD FOR ENHANCEMENT ON UL TX SWITCHING

(71) Applicant: Apple Inc., Cupertino, CA (US)

(72) Inventors: Qiming Li, Beijing (CN); Sigen Ye, San Diego, CA (US); Xiang Chen, Palo Alto, CA (US); Dawei Zhang, Saratoga, CA (US); Yang Tang, San Jose, CA (US); Jie Cui, San Jose, CA (US); Manasa Raghavan, Sunnyvale, CA (US); Ankit Bhamri, Haar Bavaria (DE); Yuexia Song, Beijing (CN); Rolando E Bettancourt Ortega, Munich (DE)

(21) Appl. No.: 19/102,070

(22) PCT Filed: Aug. 10, 2022
(86) PCT No.: PCT/CN2022/111389

§ 371 Date: Feb. 7, 2025

(51) Int. Cl. H04W 72/0453

(52) U.S. Cl. CPC H04W 72/0453

(57) ABSTRACT

The disclosure relates to system and method for enhancement on UL Tx switching. In some aspect, a user equipment (UE) may comprise at least one antenna; at least one radio coupled to the at least one antenna; and a processor coupled to the at least one radio. The at least one radio and the processor may be configured to transmit, to a network, an indication of an uplink (UL) transmission (Tx) switching capability of the UE identifying a band combination and a UL Tx switching period. The band combination may comprise a plurality of different frequency bands to be covered by a plurality of Tx chains of the UE, a number of the Tx chains is smaller than a number of the frequency bands in the band combination, and each of the plurality of Tx chains is tuned to a respective one of a plurality of initial frequency bands in the band combination. Further, the UL Tx switching period may comprise a Radio Frequency (RF) retuning period which is associated with RF retuning of at least one of the plurality of Tx chains when the at least one of the Tx chains is scheduled to be switched from the respective initial frequency band to a respective target frequency band other than the initial frequency bands in the band combination. The at least one radio and the processor may be configured to receive, from the network, an indication of the UL scheduling based on the UL Tx switching capability; and communicate with the network based on the UL scheduling after the UL Tx switching period.

### TECHNICAL FIELD

This application relates generally to wireless communication systems, including user equipments (UEs), network devices, methods, apparatus, and medium for enhancement on UL (uplink) Tx (transmission) switching.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, cNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that have been used, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

Embodiments relate to user equipments (UEs), network devices, methods, apparatus, and medium for enhancement on UL (uplink) Tx (transmission) switching.

In some aspects, a user equipment (UE) may comprise at least one antenna; at least one radio coupled to the at least one antenna; and a processor coupled to the at least one radio. The at least one radio and the processor may be configured to transmit, to a network, an indication of an uplink (UL) transmission (Tx) switching capability of the UE identifying a band combination and a UL Tx switching period. The band combination may comprise a plurality of different frequency bands to be covered by a plurality of Tx chains of the UE, a number of the Tx chains is smaller than a number of the frequency bands in the band combination, and each of the plurality of Tx chains is tuned to a respective one of a plurality of initial frequency bands in the band combination. Further, the UL Tx switching period may comprise a Radio Frequency (RF) retuning period which is associated with RF retuning of the at least one of the plurality of Tx chains when the at least one of the Tx chains is scheduled to be switched from the respective initial frequency band to a respective target frequency band other than the initial frequency bands in the band combination. The at least one radio and the processor may be configured to receive, from the network, an indication of the UL scheduling based on the UL Tx switching capability; and communicate with the network based on the UL scheduling after the UL Tx switching period.

In some aspects, a user equipment (UE) may comprise at least one antenna; at least one radio coupled to the at least one antenna; and a processor coupled to the at least one radio. The at least one radio and the processor may be configured to transmit, to a network, an indication of an uplink (UL) transmission (Tx) switching capability of the UE identifying a band combination and a band preparation period of the UE. The band combination may comprise a plurality of different frequency bands to be covered by a plurality of Tx chains of the UE, a number of the Tx chains is smaller than a number of the frequency bands in the band combination, and each of the plurality of Tx chains is tuned to a respective one of a plurality of initial frequency bands in the band combination. Also, the band preparation period may comprise at least a Radio Frequency (RF) retuning period which is associated with RF retuning of the at least one of the plurality of Tx chains when the at least one of the Tx chains is switched from the respective initial frequency band to a target frequency band other than the initial frequency bands in the band combination. The at least one radio and the processor may be configured to receive, from the network, an indication of selected frequency bands which comprise at least one frequency band other than the initial frequency bands in the band combination. The at least one radio and the processor may be configured to perform the RF retuning of the at least one of the plurality of Tx chains within the band preparation period.

In some aspects, a network device may comprise at least one antenna; at least one radio coupled to the at least one antenna; and a processor coupled to the at least one radio. The at least one radio and the processor may be configured to receive, from a user device (UE), an indication of an uplink (UL) transmission (Tx) switching capability of the UE identifying a band combination and a UL Tx switching period. The band combination may comprise a plurality of different frequency bands to be covered by a plurality of Tx chains of the UE, a number of the Tx chains is smaller than a number of the frequency bands in the band combination, and each of the plurality of Tx chains is tuned to a respective one of a plurality of initial frequency bands in the band combination. Further, the UL Tx switching period may comprise a Radio Frequency (RF) retuning period which is associated with RF retuning of the at least one of the plurality of Tx chains when the at least one of the Tx chains is scheduled to be switched from the respective initial frequency band to a respective target frequency band other than the initial frequency bands in the band combination. The at least one radio and the processor may be configured to transmit, to the UE, an indication of the UL scheduling based on the UL Tx switching capability; and communicate with the UE based on the UL scheduling after the UL Tx switching period.

In some aspects, a network device may comprise at least one antenna; at least one radio coupled to the at least one antenna; and a processor coupled to the at least one radio. The at least one radio and the processor may be configured to receive, from a user device (UE), an indication of an uplink (UL) transmission (Tx) switching capability of the UE identifying a band combination and a band preparation period of the UE. The band combination may comprise a plurality of different frequency bands to be covered by a plurality of Tx chains of the UE, a number of the Tx chains is smaller than a number of the frequency bands in the band combination, and each of the plurality of Tx chains is tuned to a respective one of a plurality of initial frequency bands in the band combination. Also, the band preparation period may comprise at least a Radio Frequency (RF) retuning period which is associated with RF retuning of the at least one of the plurality of Tx chains when the at least one of the Tx chains is switched from the respective initial frequency band to a target frequency band other than the initial frequency bands in the band combination. The at least one radio and the processor may be configured to transmit, to the UE, an indication of selected frequency bands which comprise at least one frequency band other than the initial frequency bands in the band combination.

In some aspects, methods performed by the user equipment (UE) as previously recited are provided.

In some aspects, methods performed by the network device as previously recited are provided.

In some aspects, apparatus for operating a user equipment (UE) are provided, and the apparatus comprises one or more processors to cause a user equipment (UE) device to perform the above methods.

In some aspects, apparatus for operating a network device are provided, and the apparatus comprises one or more processors to cause the network device (UE) device to perform the above methods.

In some aspects, non-transitory computer readable memory mediums storing program instructions are provided, and the instructions can be executable by one or more processors to cause a user equipment (UE) device to perform the above methods.

In some aspects, non-transitory computer readable memory mediums storing program instructions are provided, and the instructions can be executable by one or more processors to cause a network device to perform the above methods.

The techniques described herein may be implemented in and/or used with a number of different types of devices, including but not limited to cellular base stations, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates a flowchart diagram for an example method 300 at UE side for uplink (UL) transmission (Tx) switching, according to embodiments disclosed herein.

FIGS. 4A and 4B illustrates a diagram of two examples of the time mask for UL Tx switching, according to embodiments disclosed herein.

FIG. 5 illustrates a flowchart diagram for an example method 500 at UE side for uplink (UL) transmission (Tx) switching, according to embodiments disclosed herein.

FIG. 6 illustrates a flowchart diagram for an example method 700 at network side for uplink (UL) transmission (Tx) switching, according to embodiments disclosed herein.

FIG. 7 illustrates a flowchart diagram for an example method 700 at network side for uplink (UL) transmission (Tx) switching, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

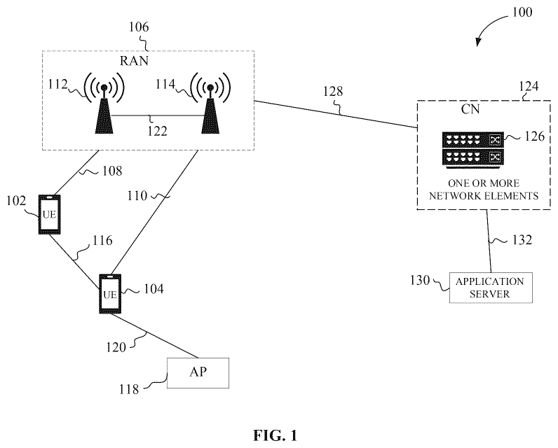

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VOIP sessions, group communication sessions, etc.) for the UE 102 and UE 104 via the CN 124. The application server 130 may communicate with the CN 124 through an IP communications interface 132.

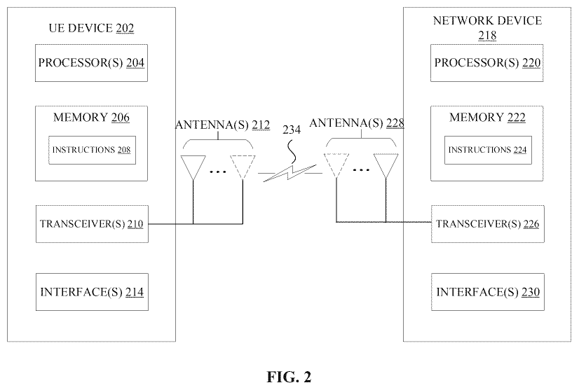

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

Nowadays, as the development of the communication technology, especially 5G, the UE can support a wide range of spectrum in different frequency ranges. Increasing availability of spectrum may be beneficial. To meet different spectrum needs, it is important to ensure that the frequency bands can be utilized in a more spectral/power efficient and flexible manner, thus providing higher throughput and decent coverage in the network.

In viewing of above, UL (uplink) Tx (transmission) switching was introduced.

For certain reasons, such as due to thermal and power consumption limitations of a UE, the UE has a limited number of radio frequency (RF) chains for processing and receiving/transmitting signals. For example, a UE may have two RF chains (e.g., two transmit (Tx) chains, two transmit/receive chains, and/or two receive (Rx) chains). In certain aspects, the UE is configured to communicate on multiple frequency carriers/bands (e.g., using carrier aggregation (CA)), such as on an uplink. For example, if the UE has two Tx chains and is configured to communicate on two bands on an uplink, in certain aspects, the UE is configured to use one Tx chain per band.

However, as an example, the UE may be configured to use UL MIMO for communicating on an uplink. In particular, the UE may use multiple Tx chains for communication using MIMO on a single band on an uplink. Thus, in the two Tx chain example discussed, the UE may need to perform UL switching, where one or more Tx chains are switched between communicating on multiple different bands. For example, a Tx chain may be switched from communicating on a first band on an uplink at a first time, to communicating on a second band on an uplink at a second time. It should be noted there may be other reasons a UE needs to support UL switching.

For multi-carrier UL operation, there are some limitations of current specification, e.g. the UE has limited number of Tx chains. UE having 2 Tx chains can be configured with at most 2 UL bands, and UL Tx switching can be only performed between 2 UL bands for the UE.

However, the UE can support a wide range of spectrum in different frequency ranges, e.g., the UE can have 3 to 4 frequency bands to be covered by the Tx chains. Therefore, more configured UL bands can be enabled for the UE than its simultaneous transmission capability and to support dynamic Tx carrier switching across the configured bands. For example, UL Tx switching schemes across up to 3 or 4 bands with restriction of up to 2 Tx simultaneous transmission will be discussed below. With the enhancement on UL Tx switching, dynamically selecting carriers with UL Tx switching e.g., based on the data traffic, TDD DL/UL configuration, bandwidths and channel conditions of each band, instead of RRC-based cell(s) reconfiguration, may potentially lead to higher UL data rate, spectrum utilization and UL capacity.

There may be at least three example schemes for dynamic Tx carrier switching across the configured bands, including:
Scheme 1: dynamic Tx carrier switching can be across all the supported frequency bands by the UE and based on the UL scheduling;
Scheme 2: one anchor band is selected among configured bands, and dynamic Tx carrier switching can be performed only between the anchor band and a non-anchor band, i.e., from the anchor band to a non-anchor band and from a non-anchor band to the anchor band; and

Scheme 3: the network indicates 2 bands out of the configured bands, and dynamic Tx carrier switching between indicated bands is the same as discussed above.

### Scheme 1

Below, various aspects relating to the above Scheme 1 are discussed. In these aspects, the UE has two simultaneous transmission chains and can be configured with three UL frequency bands.

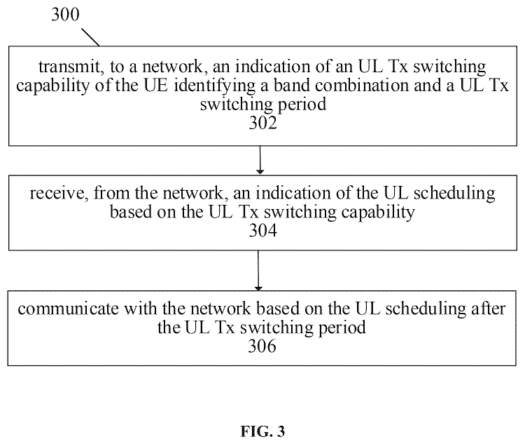

FIG. 3 illustrates a flowchart diagram for an example method 300 at UE side for uplink (UL) transmission (Tx) switching, according to aspects disclosed herein. As shown, the method of FIG. 3 may operate as follows.

At 302, a UE may transmit, to a network, an indication of an uplink (UL) transmission (Tx) switching capability of the UE, and the indication of UL Tx switching capability identifies a band combination and a UL Tx switching period for the UE to switch the Tx chains according to a UL scheduling.

For the UL Tx switching, one example of the UE capabilities is provided in the following. UE supports dynamic UL 1Tx-2Tx switching in case of inter-band Carrier Aggregation (CA), Supplementary uplink (SUL), and E-UTRA-NR Dual Connection (EN-DC), and UL 2Tx-2Tx switching in case of inter-band CA and SUL.

| | |
|---|---|
| ULTxSwitchingBandPair-r16 ::= | SEQUENCE { |
| bandIndexUL1-r16 | INTEGER(1..maxSimultaneousBands), |
| bandIndexUL2-r16 | INTEGER(1..maxSimultaneousBands), |
| uplinkTxSwitchingPeriod-r16 | ENUMERATED {n35us, n140us, n210us}, |

uplinkTxSwitching-DL-Interruption-r16 BIT STRING (SIZE(1..maxSimultaneousBands))
OPTIONAL
}

| | |
|---|---|
| ULTxSwitchingBandPair-v1700 ::= | SEQUENCE { |
| uplinkTxSwitchingPeriod2T2T-r17 | ENUMERATED {n35us, n140us, n210us} |

OPTIONAL
}

The capability signaling may comprise following parameters:

<bandIndexUL1-r16> and <bandIndexUL2-r16> indicate the band pair on which UE supports dynamic UL Tx switching. <bandindexUL1 xx> and <bandindexUL2 xx> refers to the xxth band entry in the band combination. UE shall indicate support for 2-layer UL MIMO capabilities on one of the indicated two bands in each FeatureSet entry supporting UL 1Tx-2Tx switching and indicate support for 2-layer UL MIMO capabilities on both bands in each FeatureSet entry supporting UL 2T-2Tx switching, and only the band where UE supports 2-layer UL MIMO capability can work as carrier2.

<uplinkTxSwitchingPeriod-r16> indicates the length of UL Tx switching period of 1Tx-2Tx switching per pair of UL bands per band combination when dynamic UL Tx switching is configured. UE shall not report the value n210 us for EN-DC band combinations. n35 us represents 35 us, n140 us represents 140 us, and so on.

During the switching period for the UE to perform UL switching from one band to another, communication on the uplink can be impacted. In particular, the UE may not be able to communicate on the uplink while performing UL switching for the UL Tx switching period. Thus, the switching period is an important parameter.

<uplinkTxSwitchingPeriod2T2T-r17> indicates the length of UL Tx switching period of 2Tx-2Tx switching per pair of UL bands per band combination when dynamic UL Tx switching is configured. n35 us represents 35 us, n140 us represents 140 us, and so on.

<uplinkTxSwitching-DL-Interruption-r16> indicates that DL interruption on the band will occur during UL Tx switching. When dynamic switching between two uplink carriers is conducted, UE is allowed to cause DL interruption of the downlink (DL) carrier(s) as indicated by <uplinkTxSwitching-DL-Interruption>. For example, UE is allowed to cause DL interruption of X OFDM symbols in NR downlink carrier(s).

A bit map is provided in the UE capability signaling to identify the DL interruption, where bit N in the bit map is set to “1” if DL interruption on band N will occur during uplink Tx switching. The leading/leftmost bit (bit 0) in the bit map corresponds to the first band of this band combination, the next bit in the bit map corresponds to the second band of this band combination and so on.

The signalings of the UE capabilities of the present disclosure can be constructed similarly.

In this aspect, <bandIndexUL> indicate the frequency bands of the band combination on which UE supports dynamic UL Tx switching, and the number of the Tx chains of the UE, i.e., two, is smaller than a number of the frequency bands in the band combination, i.e., three. <bandindexUL xx> refers to the xxth band entry in the band combination.

In this aspect, each of the plurality of Tx chains is tuned to one of a plurality of initial frequency bands in the band combination. Since the UE is configured with more UL frequency bands than its simultaneous transmission capability, and there is a frequency band which is not adopted by any Tx chains, and thus is not comprised in the initial frequency bands.

According to some aspects, the <uplinkTxSwitchingPeriod-r16> is defined as 35 μs, 140 μs and 210 μs, and is selected based on UE capability. That is to say, the UE which is more capable may have shorter switching period and the UE which is less capable may have longer switching period. Three lengths of switching period are provided for the UE have three different capability levels.

In some aspects, the <uplinkTxSwitchingPeriod-r16> only relates to the switching between the initial frequency bands, i.e., switching the first Tx chain to the frequency band of the second Tx chains, and/or switching the second Tx chain to the frequency band of the first Tx chains. In association with the switching of first Tx chain from its initial frequency band (first band) to the initial frequency band (second band) of the second Tx chains, since the second band is already adopted by the UE for the second Tx chain, some components relating to the RF transmission of the second Tx chain on the second band can be shared with the corresponding components relating to the RF transmission of the first Tx chain on the first band without changing the central frequency of the RF transmission of the first Tx chain on the first band. For example, the resources relating to baseband processing (e.g., filter and buffer) associated with the first Tx chain can be switched from the first band to the second band without changing the central frequency of the RF transmission of the first Tx chain on the first band. Therefore, the switching of first Tx chain from the first band to the second band of the second Tx chains can be limited and is relatively quick.

The above situations also apply to the present disclosure. In this aspect, when all the Tx chains are switched from the initial frequency band to the initial frequency band of another one of the Tx chains, or when none of the Tx chains is scheduled to be switched from the respective initial frequency band to a frequency band other than the initial frequency bands in the band combination, a first switching period is provided to define such a period. Thus, in the present disclosure, the first switching period can also be selected from a list of lengths based on band combination and UE capability, and the list of lengths includes at least one of 35 μs, 140 μs, and 210 μs.

Since the values 35 μs, 140 μs, and 210 μs generally provided for the UE have three different capability levels, these values may be larger than the actual switching time from the initial frequency band to the initial frequency band of anther one of the Tx chains, and thus the first switching period identified by these values may include an additional margin of time as compared with the actual switching time.

The length of the first switching period can also be the modified based on the actual capability of the specific UE, and thus has other lengths. Also, the length of the first switching period can also be the actual switching time.

In this aspect, since the UE is configured with more UL frequency bands than its simultaneous transmission capability, there is a situation in which the frequency band of at least one Tx chain is switched to a frequency band, which is not associated with the current frequency band of any Tx chains and thus is not comprised in the initial frequency bands. In this situation, almost all the components and resources of this Tx chain have to be switched to the target frequency band. Especially, the central frequency of the RF chain has to be tuned to the target frequency band. Thus, there is a requirement for RF retuning of the at least one of the plurality of Tx chains, and in addition to the above first switching period, a Radio Frequency (RF) retuning period associated with RF retuning of the Tx chains is further added to the UL Tx switching period. In the RF retuning period, at least one of the Tx chains is switched from the initial frequency band to a frequency band other than the initial frequency bands in the band combination.

Based on the UE capability and the frequency bands in the band combination, the RF tuning period can have different lengths. As an example, the RF tuning period is selected from a list of lengths based on band combination and UE capability, and the list of lengths includes at least one of Ous, 30 μs, 100 μs, 140 μs, 200 μs, 300 μs, 500 μs, and 900 μs. The value Ous refers to the situation in which the RF retuning period is short enough to be absorbed by the margin of the first switching period. In other words, the margin of the first switching period may be larger than the RF retuning period, and thus it is not necessary to add the RF tuning period to the first switching period.

The length of the RF retuning period can also be the modified based on the actual capability of the specific UE, and thus has other lengths. Also, the lengths of the RF retuning period can also be the actual switching time.

In one aspect of the present disclosure, a new signaling relating to the RF retuning period can be provide in the signalings of the UE capabilities, for example, <RFretunningperiod-r18> ENUMERATED {X1, X2, X3, . . . }. Where Xi can be the value from the list of the RF retuning period. The first switching period can be provided through the signaling, i.e., <uplinkTxSwitchingPeriod-r16>. Therefore, the first switching period and the RF retuning period can be provided in separate signaling of the UE capability.

Alternatively, in one aspect of the present disclosure, the lengths of the RF retuning period are predefined according to at least some frequency bands in band combination. For example, the lengths of the RF retuning period are known to the network prior to transmitting the indication of UL Tx switching capability. Therefore, the lengths of the RF retuning period are not provided to the network via UE capability, while only the indication which identifies the UE supports enhanced UL Tx switching of the present disclosure is provided to the network. For example, the lengths of the RF retuning period are predefined and are recorded in the communication protocol between the network and the UE, and thus are known to the network prior to transmitting the indication of UL Tx switching capability. By providing the above <uplinkTxSwitchingPeriod-r18> to the network, the network can be identified that the UE supports enhanced UL Tx switching of the present disclosure. Then, based on the predetermined lengths of the RF retuning period, the network is informed of the lengths of the RF retuning period.

For example, the lengths of the RF retuning period are correlated with the frequency band of the Tx chain of the UE. In one aspect of the present disclosure, the length of the RF retuning period is 500 μs for the band combination in frequency range 1 (FR1) and is 250 μs for the band combination in frequency range 2 (FR2).

In one aspect of the present disclosure, a second switching period can be provided to define the UL Tx switching period including the RF retuning period in the signalings of the UE capabilities. It can be determined that the second switching period is equal to a sum of the first switching period and the RF retuning period.

In this aspect of the present disclosure, the second switching period can be expressed as a new signaling, for example, <uplinkTxSwitchingPeriod-r18> ENUMERATED {X1, X2, X3, . . . }, where Xi can mathematically equal the sum of the first switching period and the RF retuning period. The values of Xi can be the combination obtained by permutating and summing the values from the list of the first switching period and the list of RF retuning period respectively. When the value Ous is provided for RF retuning period, as discussed above, it may indicate that the RF retuning period is short enough to be absorbed by the margin of the first switching period and thus the second switching period equals to the first switching period plus zero.

At 304, the UE may receive, from the network, an indication of a UL scheduling based on the UL Tx switching capability. The indication of a UL scheduling may indicate the frequency bands of the UL carriers, the timing of transmission with the UL carriers and so on.

At 306, the UE may communicate with the network based on the UL scheduling after the UL Tx switching period. Based on the UL scheduling, the UE may perform UL Tx switching, finish the UL Tx switching within the UL Tx switching period, and thus communicate with the network after the UL Tx switching period.

As discussed above, if at least one of the Tx chains is switched from the respective initial frequency band to the respective initial frequency band of other Tx chains, the UL Tx switching period is the first switching period. Otherwise, if at least one of the Tx chains is switched from the respective initial frequency band to a frequency band other than initial frequency bands in the band combination, RF retuning of the Tx chains is required and thus the UL Tx switching period is the second switching period which is equal to a sum of the first switching period and the RF retuning period.

### Interruption on DL Carriers

In one aspect of the present disclosure, similar to the DL interruption as discussed above, when dynamic switching between two uplink carriers is conducted, since the switching of the UL Tx chain may also affect the components used for DL carrier, UE is allowed to cause DL interruption in downlink carrier(s).

In this aspect, when downlink (DL) interruption in DL carriers of the UE is caused during the UL Tx switching period, a DL interruption period of the UE can be determined based on the second switching period. Generally speaking, the caused DL interruption becomes longer as the UL Tx switching period increases.

In this aspect, when downlink (DL) interruption in DL carriers of the UE is caused during the first switching period, i.e., when none of the Tx chains is scheduled to be switched from the respective initial frequency band to a frequency band other than the initial frequency bands in the band combination, a DL interruption period of the UE can be determined based on the first switching period, and sub-carrier space (SCS) of the DL carriers.

For example, the DL interruption lengths are defined in the following Table 1 in the unit of OFDM symbols (X).

TABLE 1

| | Slot Length | First Switching Period | | |
|---|---|---|---|---|
| μ | (ms) | 35 μs | 140 μs | 210 μs |
| 0 (SCS = 15 KHz) | 1 | 2 | 3 | 4 |
| 1 (SCS = 30 KHz) | 0.5 | 3 | 6 | 7 |
| 2 (SCS = 60 KHz) | 0.25 | 4 | 10 | 14 |

When downlink (DL) interruption in DL carriers of the UE is caused during the second switching period, i.e., when at least one of the Tx chains is scheduled to be switched from the respective initial frequency band to a respective target frequency band other than the initial frequency bands in the band combination, similar to the second switching period, the DL interruption period is affected by the RF retuning of the at least one of the plurality of Tx chains. Therefore, a DL interruption period of the UE can be determined based on the second switching period, a timing advance (TA) adjustment uncertainty of the UL carriers, and a maximum receiving timing difference (MRTD) of the DL carriers.

In one aspect of the present disclosure, a length of the DL interruption period is defined as number of interrupted OFDM symbols of the DL carrier, and is expressed as:

$${T}_{interupt} = ceil ( ( X 1 + X 2 + X 3 - X 4 ) / symbol duration ) + 1 \qquad Equation ( 1 )$$

where, X1 is the second switching period as described above, X2 is two times of Timing Advance (TA) adjustment uncertainty, X3 is two times of MRTD, X4 is a cyclic prefix (CP) length, and symbol duration is the duration of one OFDM symbol.

In one aspect of the present disclosure, the TA adjustment uncertainty is defined in the following Table 2 in which T_{c} refers to the basic timing unit in 5G:

TABLE 2

| SCS (kHz) | 15 | 30 | 60 | 120 |
|---|---|---|---|---|
| TA adjustment accuracy | ±256 T_{c} | ±256 T_{c} | ±128 T_{c} | ±32 T_{c} |

X2 is two times of TA adjustment uncertainty since the TA adjustment uncertainty is calculated for both the carrier on the initial frequency band and the carrier on the target frequency band.

In one aspect of the present disclosure, the MRTD is 3 μs if the carrier on the initial frequency band and the carrier on the target frequency band belong to same Timing Advance Group (TAG). Otherwise, the MRTD is 33 μs if the carrier on the initial frequency band and the carrier on the target frequency band belong to different Timing Advance Group (TAG).

Similarly, X3 is two times of MRTD since MRTD is calculated for both the carrier on the initial frequency band and the carrier on the target frequency band.

X4 is used to remove the difference due to one CP length, and the “+1” at the end of the equation is intended to ensure that the calculated Tᵢₙₜₑᵣᵤₚₜ is equal to or more than “1”. In one aspect of the present disclosure, X4 and the “+1” at the end of the equation can be omitted.

For OFDM communication signals, the period of interruption Tᵢₙₜₑᵣᵤₚₜ can be defined as number of interrupted OFDM symbols. The DL interruption period can start from a first OFDM symbol in the DL carriers which fully or partially overlaps with the UL Tx switching period.

It would be understood that only the DL carriers which is affected by the UL Tx switching will be interrupted. The correspondence between the frequency bands involved in the UL Tx switching and the DL carriers that will be interrupted is also identified in the UL Tx switching capability. As discussed above, a field is encoded as a bit map is provided, where bit N is set to “1” if DL interruption on band N will occur during uplink Tx switching. The leading/leftmost bit (bit 0) corresponds to the first band of this band combination, the next bit corresponds to the second band of this band combination and so on.

The DL interruption period can be determined by either the network or the UE, or both of them, since in viewing of the above description, the parameter required for determined the DL interruption is shared between the UE and the network.

### Time Mask for the UL Tx Switching

The UL Tx switching period can be located within either the Tx chain on the initial frequency band or the Tx chain on the target frequency band.

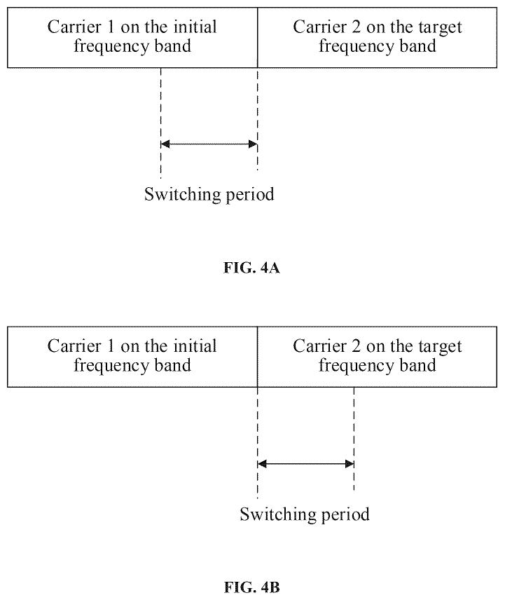

FIG. 4A and FIG. 4B illustrates a diagram of two examples of the time mask for UL Tx switching, according to embodiments disclosed herein. As shown in FIG. 4A, the UL Tx switching period is located within the Tx chain on the initial frequency band. Therefore, the transmitting on Tx chain on the target frequency band can be saved so as to take full advantage of the resource on the target frequency band. As shown in FIG. 4B, the UL Tx switching period is located within the Tx chain on the target frequency band. Therefore, the transmitting on Tx chain on the initial frequency band would not be affected such that the information on the initial frequency band will not be lost.

The time mask for UL Tx switching can be determined by the network and provided to the UE via UL scheduling.

### Scheme 2:

Below, the embodiments relating to the above Scheme 2 are discussed with reference to the above discussion on Scheme 1.

Scheme 2 is similar to Scheme 1, and the different therebetween comprises: one of the initial frequency band and target frequency band in Scheme 2 is a pre-determined anchor band, while the UL Tx switching is performed from the anchor band to a non-anchor band and from a non-anchor band to the anchor band.

The anchor band is configured in advance by the network. Normally, the anchor band is determined such that the UE has better UL communication with the network through the anchor band. The details for determining the anchor band are omitted here.

Aspects of Scheme 1 described above can be similarly applied to solutions in Scheme 2.

### Scheme 3:

Below, the embodiments relating to the above Scheme 3 is discussed.

In Scheme 3, generally speaking, the physical components of the UE are substantially the same as those in Schemes 1 and 2. That is to say, the UE has more configured UL bands than its simultaneous transmission capability and supports dynamic Tx carrier switching across the configured bands.

In contrast to Schemes 1 and 2, however, in Scheme 3, the network selects one or more frequency bands from the plurality of frequency bands to be covered by the Tx chains of the UE, and requests the UE to retune the Tx chain to the selected frequency bands. Then, dynamic Tx carrier switching is performed between selected and prepared frequency bands in the same manner as that discussed above with reference to the first switching period without RF retuning period, i.e., UL Tx switching without RF retuning of the Tx chains.

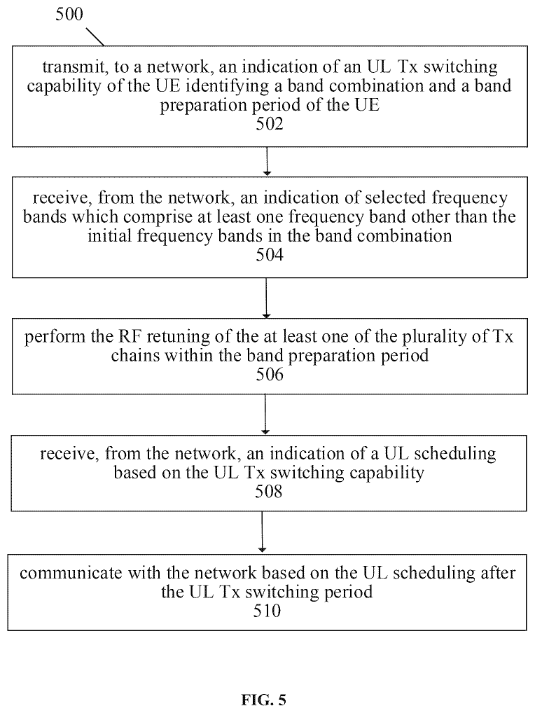

FIG. 5 illustrates a flowchart diagram for an example method 500 at UE side for uplink (UL) transmission (Tx) switching, according to embodiments disclosed herein.

At 502, a UE transmit, to a network, an indication of an uplink (UL) transmission (Tx) switching capability of the UE, the indication of UL Tx switching capability identifies a band combination comprises a plurality of different frequency bands to be covered by a plurality of Tx chains of the UE, and a band preparation period of the UE.

In one aspect of the present disclosure, initially, each of the plurality of Tx chains is tuned to the respective initial frequency band. Further, the band preparation period can comprise at least a Radio Frequency (RF) retuning period in which at least one of the Tx chains is switched from the respective initial frequency band to a target frequency band other than the initial frequency bands in the band combination. The RF retuning period is associated with RF retuning of the at least one of the plurality of Tx chains.

The RF retuning period in Scheme 3 corresponds to the RF retuning period discussed with respect to the Scheme 1.

In addition to the RF retuning period, the band preparation period further comprises the period between the sending of the indication of selected frequency bands from the network and the starting of RF retuning of the Tx chains.

Thus, if the indication of the selected frequency bands is received via MAC control element (MAC-CE), and the band preparation period comprises a period between DL data transmission of the indication of selected frequency bands and acknowledgement, a MAC-CE processing time, and the RF retuning period.

In particular, if network indicates the indication of the selected frequency bands via MAC-CE:

$${T}_{preparation} = {T}_{HARQ} + {T}_{MAC - CE} + {T}_{RF} \qquad Equation ( 2 )$$

where T_{HARQ} is the timing between DL data transmission and acknowledgement, T_{MAC-CE} is MAC-CE processing time, which is up to 3 ms, and T_{RF} is RF retuning ₜᵢₘₑ, which is same as introduced in Scheme 1.

If the indication of selected frequency bands is received via Downlink Control Information (DCI), the band preparation period is substantially equal to the RF retuning period due to the short transmitting and processing period of the DCI, i.e., Tₚᵣₑₚₐᵣₐₜᵢₒₙ=T_{RF}.

At 504, the UE receive, from the network, an indication of the selected frequency bands. The selected frequency bands can comprise at least one frequency bands other than the initial frequency bands in the band combination. It can be understood that if the selected frequency bands are all comprised in the initial frequency bands, it may not be necessary to RF retuning the Tx chains since there already are Tx chains on this frequency band.

At 506, the UE perform the RF retuning of the at least one of the plurality of Tx chains within the band preparation period.

Thereafter, the UE is prepared to perform UL Tx Chain switching between the indicated frequency bands.

### First DL Interruption Due to Band Preparation

Similar to the above described UL Tx switching in Scheme 1 and 2, during RF retuning of the Tx chains, communications on the DL carriers can be interrupted.

In one aspect of the present disclosure, when a first downlink (DL) interruption in DL carriers of the UE is caused during the band preparation period, a first DL interruption period of the UE can be determined based on sub-carrier space (SCS) of the DL carriers, a frequency band of the DL carriers, and the selected frequency bands of the Tx carriers.

In one aspect of the present disclosure, Tᵢₙₜₑᵣᵣᵤₚₜ is defined as in the following Table 3. In the Table 3, aggressor cell refers to the cell involving Tx chain retuning. Other serving cells are considered as victim cells.

TABLE 3

| | NR Slot length | | |
|---|---|---|---|
| μ | (ms) of victim cell | Interruption length X2 (slots) | |
| 0 (SCS = 15 KHz) | 1 | | 1 |
| 1 (SCS = 30 KHz) | 0.5 | | 1 |
| 2 (SCS = 60 KHz) | 0.25 | Both aggressor cell and | 2 |
| | | victim cell are on FR2 | |
| | | Either aggressor cell or | 3 |
| | | victim cell is on FR1 | |
| 3 (SCS = 120 KHz) | 0.125 | Aggressor cell is on FR2 | 4 |
| | | Aggressor cell is on FR1 | 5 |

As shown in Table 3, the length of the first DL interruption period is defined as a number of slots (X2) of the DL carrier and ranges from 1 to 5.

Similar to the interruption in Scheme 1, the first DL interruption period starts from the first OFDM symbol in the DL carriers which fully or partially overlaps with the band preparation period.

### UL Tx Switching Period

After the UE is prepared to perform UL Tx Chain switching between the indicated frequency bands, the process of dynamic Tx switching may be performed between indicated bands which correspond to the initial frequency bands of the Tx chains, and this process is same as that discussed above with reference to the first switching period, i.e., without RF retuning of the Tx chains.

In particular, the indication of UL Tx switching capability may further identify a UL Tx switching period in which at least one of the Tx chains is switched from the selected frequency band to the selected frequency band of another one of the Tx chains. The indication of the UL Tx switching capability may be similar to those used for the UE capability as discussed above.

The UL Tx switching period in this aspect is similar to the first switching period as discussed above. Therefore, the aspects associated with the first switching period can be applied to the UL Tx switching period in this aspect.

Further, at 508 as shown in FIG. 5, the UE receive, from the network, an indication of a UL scheduling based on the UL Tx switching capability. The indication of a UL scheduling may indicate the frequency bands of the UL carriers, the timing of transmission with the UL carriers and so on.

At 510, the UE may communicate with the network based on the UL scheduling after the UL Tx switching period. Based on the UL scheduling, the UE may perform UL Tx switching, finish the UL Tx switching within the UL Tx switching period, and thus communicate with the network after the UL Tx switching period.

It should be understood that 508 and 510 are optional and thus may not be comprised in the method of this aspect.

### Second DL Interruption Due to UL Tx Switching

Similar to the DL interruption discussed above, especially the DL interruption caused during the first switching period, a second DL interruption may occur during the UL Tx switching in Scheme 3.

The UL Tx switching period in this aspect is similar to the DL interruption caused during the first switching period as discussed above. The contents associated with the DL interruption caused during the first switching period can be applied to the UL Tx switching period in this aspect.

Similarly, when a second DL interruption in DL carriers of the UE is caused during the UL Tx switching period, the second DL interruption period of the UE can be determined based on sub-carrier space (SCS) of the DL carriers and the UL Tx switching period. Further, the length of the second DL interruption period is defined as a number of interrupted OFDM symbols of the DL carrier and ranges from 2 to 14.

Embodiments contemplated herein include an apparatus comprising means to perform one or more elements of the methods 300 and 500. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the methods 300 and 500. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the methods 300 and 500. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the methods 300 and 500. This apparatus may be, for example, an apparatus of a UE (such as a wireless device 202 that is a UE, as described herein).

Embodiments contemplated herein include a signal as described in or related to one or more elements of the methods 300 and 500.

Embodiments contemplated herein include a computer program or computer program product comprising instructions, wherein execution of the program by a processor is to cause the processor to carry out one or more elements of the methods 300 and 500. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

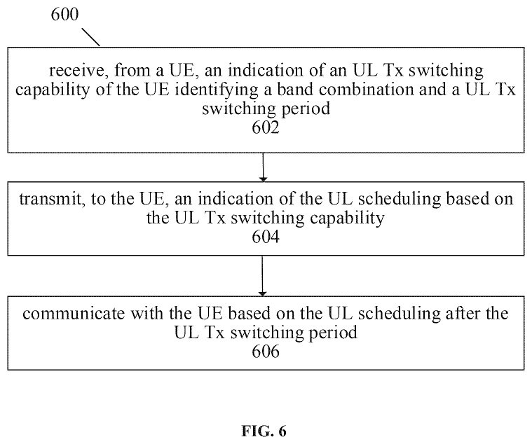

FIG. 6 illustrates a flowchart diagram for an example method 600 at network side for uplink (UL) transmission (Tx) switching, according to embodiments disclosed herein. As shown, the method of FIG. 6 may operate as follows.

At 602, the network device receives, from a user device (UE), an indication of an uplink (UL) transmission (Tx) switching capability of the UE identifying a band combination and a UL Tx switching period.

At 604, the network device transmits, to the UE, an indication of the UL scheduling based on the UL Tx switching capability.

At 606, the network communicates with the UE based on the UL scheduling after the UL Tx switching period.

The method 600 is similar to the methods 300 and 500, and the details of method 600 are omitted here.

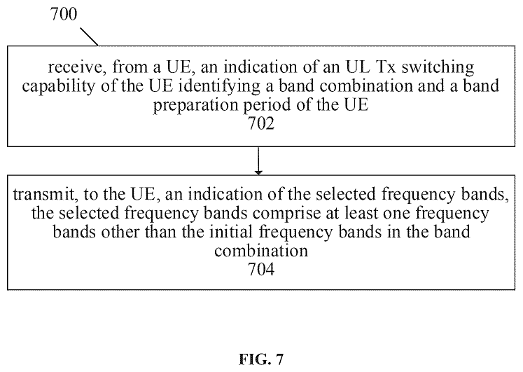

FIG. 7 illustrates a flowchart diagram for an example method 700 at network side for uplink (UL) transmission (Tx) switching, according to embodiments disclosed herein. As shown, the method of FIG. 7 may operate as follows.

At 702, the network device receive, from a user device (UE), an indication of an uplink (UL) transmission (Tx) switching capability of the UE identifying a band combination and a band preparation period of the UE.

At 704, the network device transmit, to the UE, an indication of the selected frequency bands, the selected frequency bands comprise at least one frequency bands other than initial frequency bands in the band combination.

The method 700 is similar to the method 500, and the details of method 700 are omitted here.

Embodiments contemplated herein include an apparatus comprising means to perform one or more elements of the methods 600 and 700. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the methods 600 and 700. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the methods 600 and 700. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the methods 600 and 700. This apparatus may be, for example, an apparatus of a base station (such as a network device 218 that is a base station, as described herein).

Embodiments contemplated herein include a signal as described in or related to one or more elements of the methods 600 and 700.

Embodiments contemplated herein include a computer program or computer program product comprising instructions, wherein execution of the program by a processing element is to cause the processing element to carry out one or more elements of the methods 600 and 700. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

With the enhancement on UL Tx switching of the present disclosure, dynamically selecting carriers with UL Tx switching e.g., based on the data traffic, TDD DL/UL configuration, bandwidths and channel conditions of each band, instead of RRC-based cell(s) reconfiguration, may potentially lead to higher UL data rate, spectrum utilization and UL capacity.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus, comprising:
a memory configured to store instructions; and
a processor coupled to the memory and when executing the instructions, configured to;
generate, for transmission to a network, an indication of an uplink (UL) transmission (Tx) switching capability of a user equipment (UE), the UL Tx switching capability identifying a band combination and a UL Tx switching period,
wherein the band combination comprises a plurality of different frequency bands to be covered by a plurality of Tx chains of the UE, a number of the Tx chains is smaller than a number of the frequency bands in the band combination, and
wherein the UL Tx switching period comprises a Radio Frequency (RF) retuning period which is associated with RF retuning of at least one of the plurality of Tx chains;
receive, from the network, an indication of the UL scheduling based on the UL Tx switching capability; and
communicate with the network based on the UL scheduling after the UL Tx switching period.

2. The apparatus of claim 1, wherein lengths of the RF retuning period comprise at least one value selected from a first list of lengths based on the band combination and UE capability.

3. The apparatus of claim 2, wherein the list of lengths includes at least one of 0 μs, 30 μs, 100 μs, 140 μs, 200 μs, 300 μs, 500 μs, and 900 μs.

4. The apparatus of claim 1, wherein each of the plurality of Tx chains is tuned to a respective one of a plurality of initial frequency bands in the band combination, and the at least one of the Tx chains is scheduled to be switched from the respective initial frequency band to a respective target frequency band other than the initial frequency bands in the band combination, and
wherein the UL Tx switching period is a first switching period when none of the Tx chains are scheduled to be switched from the respective initial frequency band to a target frequency band, and the UL Tx switching period is a second switching period when at least one of the Tx chains is scheduled to be switched from the respective initial frequency band to a respective target frequency band, and
wherein the second switching period is equal to a sum of the first switching period and the RF retuning period.

5. The apparatus of claim 4, wherein lengths of the first switching period comprise at least one value is selected from a second list of lengths based on the band combination and UE capability.

6. The apparatus of claim 5, wherein the second list of lengths includes at least one of 35 μs, 140 μs, and 210 μs.

7. The apparatus of claim 1, wherein a length of the RF retuning period is predefined according to at least some frequency bands in the band combination.

8. The apparatus of claim 7, wherein the length of the RF retuning period is 500 μs when the frequency bands in the band combination are in frequency range 1 (FR1) and the length of the RF retuning period is 250 μs when the frequency bands in the band combination are in frequency range 2 (FR2).

9. The apparatus of claim 4, wherein at least one of the initial frequency bands and the target frequency bands is an anchor band determined by the network.

10. The apparatus of claim 4, wherein when a downlink (DL) interruption in DL carriers of the UE is caused during the second switching period, a DL interruption period of the DL interruption is determined based on the second switching period, a timing advance (TA) adjustment uncertainty of UL carriers, and a maximum receiving timing difference (MRTD) of the DL carriers.

11. The apparatus of claim 10, wherein a length of the DL interruption period is defined as a number of interrupted OFDM symbols of the DL carrier, and is expressed as:
Tᵢₙₜₑᵣᵤₚₜ=ceil((X1+X2+X3−X₄)/symbol duration)+1
where
X1 is the second switching period,
X2 is two times of TA adjustment uncertainty,
X3 is two times of MRTD,
X4 is a cyclic prefix (CP) length, and
symbol duration is the duration of one OFDM symbol.

12. The apparatus of claim 4, wherein when none of the Tx chains are scheduled to be switched from the respective initial frequency band to a target frequency band other than the initial frequency bands in the band combination, and when a downlink (DL) interruption in DL carriers of the UE is caused during the UL Tx switching period, a DL interruption period of the DL interruption is determined based on the first switching period and sub-carrier space (SCS) of the DL carriers.

13. The apparatus of claim 12, wherein a length of the DL interruption period is defined as a number of interrupted OFDM symbols of the DL carrier and ranges from 2 to 14.

14. The apparatus of claim 13, wherein the DL interruption period starts from a first OFDM symbol in the DL carriers which fully or partially overlaps with the first switching period.

15-24. (canceled)

25. A network device, comprising:
at least one antenna;
at least one radio coupled to the at least one antenna; and
a processor coupled to the at least one radio;
wherein the at least one radio and the processor are configured to:
receive, from a user device (UE), an indication of an uplink (UL) transmission (Tx) switching capability of the UE identifying a band combination and a band preparation period of the UE,
wherein the band combination comprises a plurality of different frequency bands to be covered by a plurality of Tx chains of the UE, a number of the Tx chains is smaller than a number of the frequency bands in the band combination, and each of the plurality of Tx chains is tuned to a respective one of a plurality of initial frequency bands in the band combination, and
wherein the band preparation period comprises at least a Radio Frequency (RF) retuning period which is associated with RF retuning of the at least one of the plurality of Tx chains; and
transmit, to the UE, an indication of selected frequency bands which comprise at least one frequency band other than the initial frequency bands in the band combination.

26. A method, comprising:
by a user equipment (UE),
transmitting, to a network, an indication of an uplink (UL) transmission (Tx) switching capability of the UE identifying a band combination and a UL Tx switching period,
wherein the band combination comprises a plurality of different frequency bands to be covered by a plurality of Tx chains of the UE, a number of the Tx chains is smaller than a number of the frequency bands in the band combination, and
wherein the UL Tx switching period comprises a Radio Frequency (RF) retuning period which is associated with RF retuning of at least one of the plurality of Tx chains; and
receiving, from the network, an indication of the UL scheduling based on the UL Tx switching capability; and
communicating with the network based on the UL scheduling after the UL Tx switching period.

27-33. (canceled)

34. The network device of claim 25, wherein the at least one of the Tx chains is switched from the respective initial frequency band to a target frequency band other than the initial frequency bands in the band combination.

35. The method of claim 26, wherein each of the plurality of Tx chains is tuned to a respective one of a plurality of initial frequency bands in the band combination and the at least one of the Tx chains is switched from the respective initial frequency band to a target frequency band other than the initial frequency bands in the band combination.

36. The method of claim 35, wherein the UL Tx switching period is a first switching period when none of the Tx chains are scheduled to be switched, and the UL Tx switching period is a second switching period when at least one of the Tx chains is scheduled to be switched, and
wherein the second switching period is equal to a sum of the first switching period and the RF retuning period.

37. The method of claim 26, wherein lengths of the RF retuning period comprise at least one value selected from a first list of lengths based on the band combination and UE capability.
